(19) United States
(12) Patent Application Publication
(10) Pub. No.: US 2025/0138835 A1
(43) Pub. Date: May 1, 2025

(54) INFORMATION OUTPUTTING METHOD, INFORMATION PROCESSING APPARATUS, AND STORAGE MEDIUM

(71) Applicant: Panasonic Intellectual Property Corporation of America, Torrance, CA (US)

(72) Inventors: Atsushi NISHIMURA, Osaka (JP); Masataka UEMURA, Nara (JP); Hirokazu KITO, Osaka (JP)

(73) Assignee: Panasonic Intellectual Property Corporation of America, Torrance, CA (US)

(21) Appl. No.: 19/011,182

(22) Filed: Jan. 6, 2025

Related U.S. Application Data
(63) Continuation of application No. PCT/JP2023/012951, filed on Mar. 29, 2023.

(30) Foreign Application Priority Data
Aug. 3, 2022 (JP) 2022-124152

(51) Int. Cl. G06F 9/445

(52) U.S. Cl. CPC G06F 9/445

(57) ABSTRACT

An information processing apparatus acquires operation information of a plurality of devices. The information processing apparatus specifies a function of a second device that is not operated in a case where the function of the second device corresponding to a function operated in a first device is not operated based on the operation information and function information in which common functions are associated with each other out of functions of each of the plurality of devices in advance. The information processing apparatus outputs information regarding the specified function of the second device. The plurality of devices is divided into a plurality of categories. In the specifying, the function of the second device belonging to the same category as that of the first device is specified with priority.

### BACKGROUND

### 1. Field

The present disclosure relates to a data processing technology, and especially relates to an information outputting method, an information processing apparatus, and a storage medium.

### 2. Description of the Related Art

Following Patent Literature 1 discloses a technology in which, when a user data server receives an input of washing-related information, the user data server adjusts a washing control program for executing an operation of a laundry device based on the washing-related information.
[Patent Literature 1] JP 2002-85885 A

Multifunctionality of devices has progressed, and it is not easy for a user to understand and use various functions of each of a plurality of devices installed in an environment such as a house. For example, a plurality of devices may have functions having different names but similar operations, but it is not easy for the user to grasp similar functions between devices and use each device.

### SUMMARY

The present disclosure has been made based on the above-described problem recognition, and an object thereof is to provide a technology of supporting an operation of a certain device to conform to an operation of another device in an environment in which a plurality of devices is installed.

In order to solve the above-described problem, an information outputting method of an aspect of the present disclosure acquires operation information of a plurality of devices, specifies a function of a second device that is not operated in a case where the function of the second device corresponding to a function operated in a first device is not operated based on the operation information and function information in which common functions are associated with each other out of functions of each of the plurality of devices in advance, and outputs information regarding the specified function of the second device.

Another aspect of the present disclosure relates to an information processing apparatus. This apparatus includes an acquisition unit that acquires operation information of a plurality of devices, a specifier that specifies a function of a second device that is not operated in a case where the function of the second device corresponding to a function operated in a first device is not operated based on the operation information and function information in which common functions are associated with each other out of functions of each of the plurality of devices in advance, and an outputter that outputs information regarding the specified function of the second device.

Optional combinations of the aforementioned constituting elements, and implementations of the present disclosure in the form of systems, computer programs, and recording mediums recording computer programs may also be practiced as additional aspects of the present disclosure.

### BRIEF DESCRIPTION OF THE DRAWINGS

FIG. 1 is a diagram illustrating a configuration of an information processing system of an embodiment;

FIG. 2 is a block diagram illustrating functional blocks of an information processing apparatus of FIG. 1;

FIG. 3 is a view illustrating an example of a function correspondence rule;

FIG. 4 is a flowchart illustrating an operation of the information processing apparatus of FIG. 1;

FIG. 5 is a view illustrating an example of operation information of environment control devices and seasonal devices;

FIG. 6 is a view illustrating an example of the operation information of cooking devices;

FIGS. 7A and 7B are views illustrating an example of recommended function information displayed on a second device; and

FIG. 8 is a view illustrating an example of function attribute-related information.

### DETAILED DESCRIPTION OF THE EMBODIMENTS

The invention will now be described by reference to the preferred embodiments. This does not intend to limit the scope of the present invention, but to exemplify the invention.

An apparatus or an entity that executes a method according to the present disclosure is provided with a computer. By causing the computer to run a program, a function of the apparatus or the entity that executes the method according to the present disclosure is implemented. The computer is comprised of a processor that operates in accordance with the program as a main hardware feature. The disclosure is non-limiting as to the type of the processor so long as the function is implemented by running the program. The processor is comprised of one or a plurality of electronic circuits including a semiconductor integrated circuit (IC) or a large-scale integration (LSI). The terms IC and LSI may change depending on the level of integration, and the processor may be comprised of a system LSI, a very large scale integration (VLSI), or an ultra large scale integration (ULSI). A field programmable gate array (FPGA), which is programmed after the LSI is manufactured, or a reconfigurable logic device, in which connections inside the LSI can be reconfigured or circuit compartments inside the LSI can be set up, can be used for the same purpose. The plurality of electronic circuits may be integrated in one chip or provided in a plurality of chips. The plurality of chips may be aggregated in one device or provided in a plurality of devices. The program may be recorded in a computer-readable non-transitory recording medium such as a read only memory (ROM), an optical disk, and a hard disk drive or recorded in a computer-readable transitory storage medium such as a random access memory (RAN). The program may be stored in a recording medium in advance or supplied to a recording medium or a storage medium via a wide area communication network including the Internet.

### Exemplary Embodiment

An outline of an embodiment will be described. Multifunctionality of devices has progressed, and it is not easy for a user to understand and use various functions of each of a plurality of devices installed in an environment such as a house. For example, a plurality of devices may have functions having different names but similar operations. It is possible to increase the function of the device by downloading a program after purchasing the device. Under such circumstances, it may take time cost for the user to understand and use the functions of each device, and the user may feel annoyed.

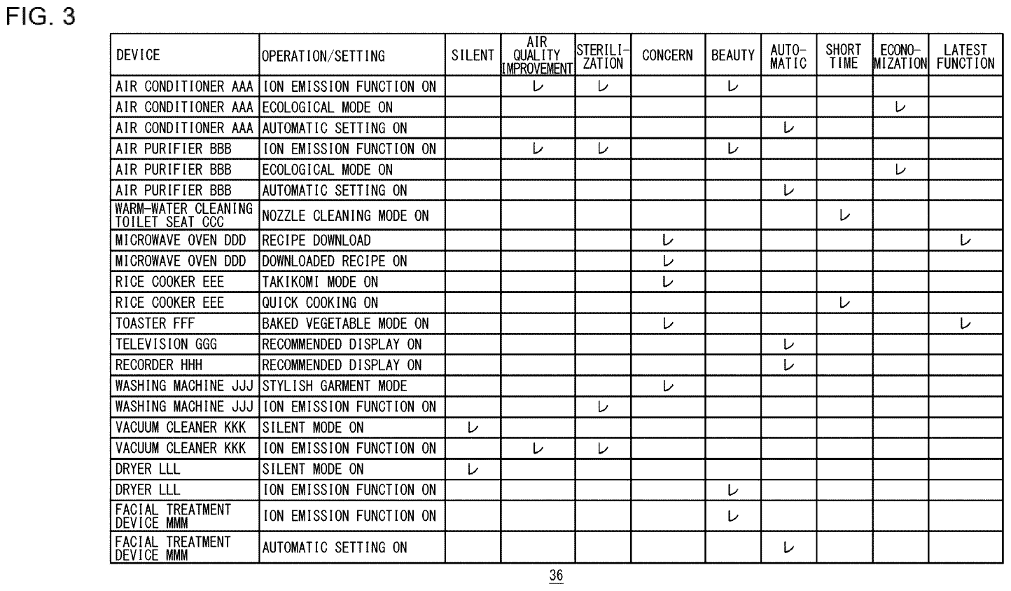

Therefore, an information processing system of the embodiment supports an operation of a certain device in the environment to conform to an operation of another device using information in which a plurality of functions provided by a plurality of devices installed in the environment to be analyzed is associated with each other (for example, a function correspondence rule to be described later in relation to FIG. 3) and operation information of the plurality of devices. In other words, the information processing system of the embodiment first manages, as the functions, the same or similar functions in association with each other out of the functions of each of a plurality of home appliances. The information processing system of the embodiment further estimates a function in which the user is highly interested according to a use status of the plurality of home appliances by the user, and proposes the use of the function to the user out of the plurality of home appliances.

In the embodiment, the environment to be analyzed in which the plurality of devices is installed is a house in which a plurality of users (for example, a user A, a user B, and a user C) forming a family lives, but the environment to which the technology of the present disclosure can be applied is not limited to the house. The environment may be an office or a commercial facility. In the embodiment, a device to be processed means a device installed in a space and connected via a network. For example, in addition to home appliances such as a refrigerator, an air conditioner, and a TV, housing devices such as an outlet, a switch, and a dimming system are included.

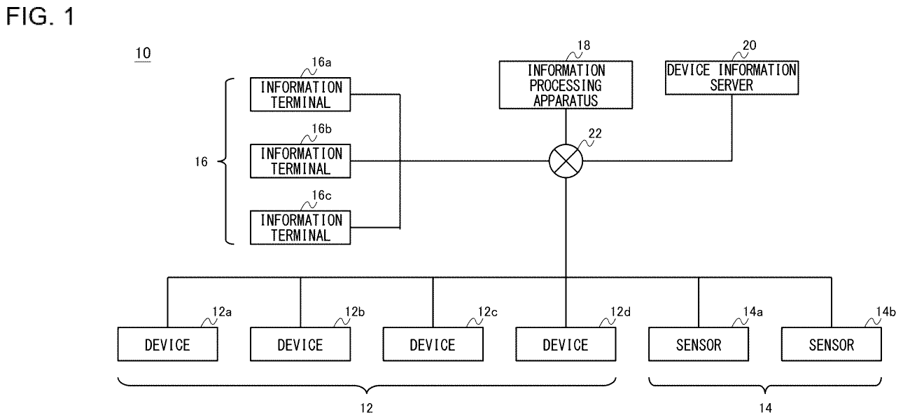

FIG. 1 illustrates a configuration of an information processing system 10 of the embodiment. The information processing system 10 includes a plurality of devices 12, a plurality of sensors 14, a plurality of information terminals 16, an information processing apparatus 18, and a device information server 20. The apparatuses forming the information processing system 10 are connected via a communication network 22 including LAN, WAN, the Internet and the like.

The plurality of devices 12 includes a device 12a, a device 12b, a device 12c, and a device 12d. Each of the plurality of devices 12 includes a home appliance and facility. Each of the plurality of devices 12 has a communication function and transmits and receives data to and from the information processing apparatus 18 via the communication network 22. A “first device 12” in the following description means a specific device 12 a function of which is operated by the user out of the plurality of devices 12. A “second device 12” means a device 12 different from the first device 12 out of the plurality of devices 12, and means a device 12 in which a function corresponding to the function operated in the first device 12 is not operated. In the embodiment, the function corresponding to the operated function means a function the same as or similar to the operated function and can implement an environment equivalent to that of the operated function in a case where the device is operated.

The plurality of devices 12 is classified into a plurality of categories (also referred to as classifications). The plurality of categories is obtained by classifying the devices having the same or similar functions based on the functions of the devices, and includes, for example, (1) environment control devices and seasonal devices, (2) cooking devices, (3) audio-visual (AV) devices, (4) living devices, and (5) beauty devices and health devices. (1) The environment control devices and seasonal devices include an air conditioner, an air purifier, a warm-water cleaning toilet seat, and a humidifier. (2) The cooking devices include a microwave oven, a rice cooker, a toaster, and an IH cooking heater. (3) The AV devices include a television and a recorder. (4) The living devices include a washing machine and a vacuum cleaner. (5) The beauty devices and health devices include a dryer and a facial treatment device.

The plurality of devices 12 includes an apparatus that can be used (in other words, operated) by a plurality of users. Conversely, a device having a function of limiting a user in such a manner that only a specific user can use the device (for example, an authentication function using a password, a fingerprint and the like) such as a smartphone and a tablet terminal may be excluded from the device 12 to be analyzed. However, even with the device having the function of limiting the user, in a case where a plurality of users can enjoy the benefit of the operation, the device may be included in the device 12 to be analyzed.

The plurality of sensors 14 includes a sensor 14a and a sensor 14b. The plurality of sensors 14 detects various pieces of information regarding the operation of the corresponding device 12. At least a part of the plurality of sensors 14 may be an apparatus that identifies or authenticates the user who uses the corresponding device 12. At least a part of the plurality of sensors 14 may be incorporated in the corresponding device 12. At least a part of the plurality of sensors 14 may be provided separate from the corresponding device 12. The plurality of sensors 14 may include at least one of a camera, a microphone, an infrared sensor, an ultrasonic sensor, a fingerprint sensor, or an iris sensor.

The plurality of information terminals 16 includes an information terminal 16a, an information terminal 16b, and an information terminal 16c. The plurality of information terminals 16 is apparatuses operated by different users. For example, the information terminal 16a may be operated by the user A, the information terminal 16b may be operated by the user B, and the information terminal 16c may be operated by the user C. Each of the plurality of information terminals 16 may be a home appliance or facility including a user interface (for example, a display unit and the like), a computer, a tablet terminal, or a smartphone.

The information processing apparatus 18 executes information processing for supporting an operation of a certain device in a house to conform to an operation of another device using information in which functions corresponding to each other are associated with each other out of functions of each of the plurality of devices 12 installed in the house and operation information of each of the plurality of devices 12. That is, the function of the device used by the user is specified using the operation information of the device used by the user out of the plurality of devices 12, and when the user has a third device (i.e. third-party device) having a function corresponding to this used function, the corresponding function of the third device is provided to the user. The information processing apparatus 18 of the embodiment is a cloud server that is installed in a cloud and provides a service of the information processing described above as a cloud service. As a variation, the information processing apparatus 18 may be an edge server installed in the environment in which the device 12 is installed, in other words, in the environment (for example, house) in which the user uses the device 12. The function of the information processing apparatus 18 may be incorporated in the information terminal 16 operated by the user.

The device information server 20 receives identification information of the device 12 from the information processing apparatus 18, and provides information regarding the device 12 identified by the received identification information (hereinafter, also referred to as “device information”) to the information processing apparatus 18. The device information of the embodiment is information in which the identification information of the device 12, one or more functions of the device 12, and an attribute (attribute for classification) of each function are associated with each other. That is, the device information of the embodiment includes an item of the function correspondence rule to be described later.

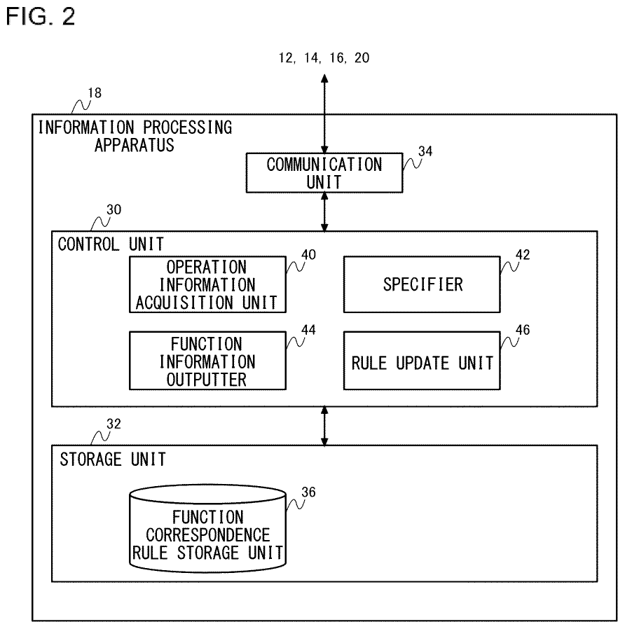

FIG. 2 is a block diagram illustrating functional blocks of the information processing apparatus 18 of FIG. 1. The blocks illustrated in the block diagram of the present disclosure can be implemented in hardware by an element and a mechanical apparatus such as a CPU and a memory of a computer, and in software by a computer program and the like; herein, functional blocks implemented by cooperation of them are illustrated. It will be understood by those skilled in the art that these functional blocks can be implemented in a variety of manners by a combination of hardware and software.

The information processing apparatus 18 includes a control unit 30, a storage unit 32, and a communication unit 34. The control unit 30 controls an operation of the information processing apparatus 18. The control unit 30 is also referred to as a data processing unit and executes various pieces of data processing and arithmetic processing. The control unit 30 may be implemented by a processor (CPU and the like) of the information processing apparatus 18. The storage unit 32 stores data referenced or updated by the control unit 30. The communication unit 34 communicates with an external device according to a predetermined communication protocol. The control unit 30 transmits and receives data to and from the device 12, the sensor 14, the information terminal 16, and an external apparatus such as the device information server 20 via the communication unit 34.

The storage unit 32 includes a function correspondence rule storage unit 36. The function correspondence rule storage unit 36 stores data in which common functions are associated with each other out of the functions of each of the plurality of devices 12 in advance as “function correspondence rule data”. FIG. 3 illustrates an example of the function correspondence rule. The function correspondence rule is information indicating functions corresponding to each other among the plurality of devices 12. Specifically, the function correspondence rule is information in which functions of each of the plurality of devices 12 having a common attribute are associated with each other. In other words, the function correspondence rule is information in which the functions of each of the plurality of devices 12 are associated with each other based on the attribute of the function. The attribute of the function can also be referred to as a feature or utility of the function. In the example of FIG. 3, a function “recipe download” of a microwave oven DDD and a function “baked vegetable mode” of a toaster FFF are associated with each other based on an attribute “latest function”. Note that, the function correspondence rule can also be said to be information obtained by classifying operation units of the device according to function axes and defining a correspondence relationship of the operation units among the plurality of devices.

Returning to FIG. 2, the control unit 30 includes an operation information acquisition unit 40, a specifier 42, a function information outputter 44, and a rule update unit 46. The functions of these plurality of function blocks may be implemented in a computer program, and the computer program may be installed in a storage of the information processing apparatus 18. The processor of the information processing apparatus 18 may exhibit the functions of the plurality of functional blocks described above by reading this computer program into a main memory and running the program.

The operation information acquisition unit 40 acquires the operation information of the plurality of devices 12 installed in the house. In the embodiment, the operation information acquisition unit 54 acquires the operation information transmitted from each of the plurality of devices 12. As a variation, the operation information acquisition unit 54 may acquire the operation information of the device 12 to be monitored from the sensor 14 that monitors or detects a state of the device 12. The information processing system 10 may include a database that accumulates and stores the operation information of the plurality of devices 12, and the operation information acquisition unit 54 may periodically acquire the operation information of the device 12 from the database.

Based on the operation information acquired by the operation information acquisition unit 40 and the function correspondence rule stored in the function correspondence rule storage unit 36, in a case where the function of the second device 12 corresponding to the function operated in the first device 12 is not operated, the specifier 42 specifies the function of the second device 12 that is not operated.

The function information outputter 44 outputs information regarding the function (hereinafter, also referred to as a “recommended function”) of the second device 12 specified by the specifier 42. The information regarding the recommended function includes a content prompting the user to use the function of the second device 12 specified by the specifier 42, and is hereinafter also referred to as “recommended function information”. The recommended function information may include information indicating the first device 12 used by the user and information indicating the function operated by the user in the first device 12 in addition to the information indicating the function of the second device 12 that the user is prompted to use.

In this embodiment, the function information outputter 44 transmits, to the information terminal 16, display data of the content prompting use of the function of the second device 12 specified by the specifier 42 as the recommended function information, and causes a display unit of the information terminal 16 to display the content. The display data may include, for example, a name of the second device 12, and an image or text indicating the name or attribute of the recommended function in the second device 12. As a variation, the function information outputter 44 may transmit, to the information terminal 16, voice data of the content prompting use of the function of the second device 12 specified by the specifier 42 as the recommended function information, and output the content from a speaker of the information terminal 16.

In this embodiment, the function information outputter 44 outputs the recommended function information to an apparatus different from the information processing apparatus 18 (for example, the information terminal 16 as a personal terminal or a shared terminal). As a variation, the information processing apparatus 18 may include an outputter (display unit and the like not illustrated) that outputs information to the outside. In this case, the function information outputter 44 may output (display or voice output) the recommended function information from the outputter.

In a case of outputting the recommended function information to an apparatus different from the information processing apparatus 18, an output destination apparatus may be determined for each second device 12. For example, the storage unit 32 may store information of the information terminal 16 possessed by each of a plurality of users. In a case where the recommended function information should be output, the function information outputter 44 may specify the user (operating user) who operates the corresponding first device 12 indicated by the operation information used when specifying the recommended function. The function information outputter 44 may transmit the recommended function information to the information terminal 16 of the specified operating user.

When a new device 12 is installed in the house, the rule update unit 46 updates the function correspondence rule stored in the function correspondence rule storage unit 36 based on information regarding the new device 12.

An operation of the information processing system 10 of the first embodiment according to the above-described configuration will be described.

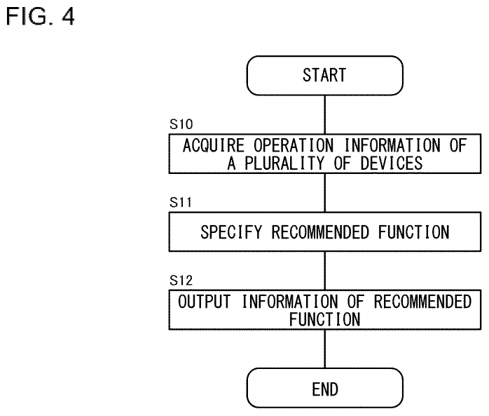

FIG. 4 is a flowchart illustrating an operation of the information processing apparatus 18 of FIG. 1. The function correspondence rule storage unit 36 of the information processing apparatus 18 stores in advance the function correspondence rule matching an installation status of the plurality of devices 12 in the house. For example, the rule update unit 46 of the information processing apparatus 18 may receive the identification information of the plurality of devices 12 installed in the house input from the information terminal 16 of the user, and acquire the device information of the plurality of devices 12 from the device information server 20 based on the received identification information. The rule update unit 46 may store the device information of the plurality of devices 12 acquired from the device information server 20 in the function correspondence rule storage unit 36 as the function correspondence rule.

The function correspondence rule storage unit 36 may associate room layout information of the house with the installation status of the plurality of devices 12, and store the function correspondence rule matching the installation status of the plurality of devices 12. The room layout information is information indicating arrangement of rooms in a house, and includes information indicating functions of rooms such as a living room, a bedroom, and a kitchen, information regarding a size of the room measured by square meters and the like. When the room layout information and the installation status of the plurality of devices 12 are associated with each other in this manner, the operation information of the plurality of devices 12 can be acquired in accordance with a life rhythm of the user, the size of the space and the like, so that it is possible to output the information regarding the function of the device suitable for the life rhythm of the user or the living space.

The user (for example, the user A, the user B, and the user C) who lives in the house operates the device 12 to operate the device 12 in daily life. The device 12 generates operation information (also referred to as an operation log), which is information regarding an operation based on the operation of the user, and transmits the operation information to the information processing apparatus 18. Note that, the device 12 may generate the operation information including information detected by the sensor 14 (for example, information of the operating user). The operation information acquisition unit 54 of the information processing apparatus 18 acquires the operation information transmitted from the device 12 (S10).

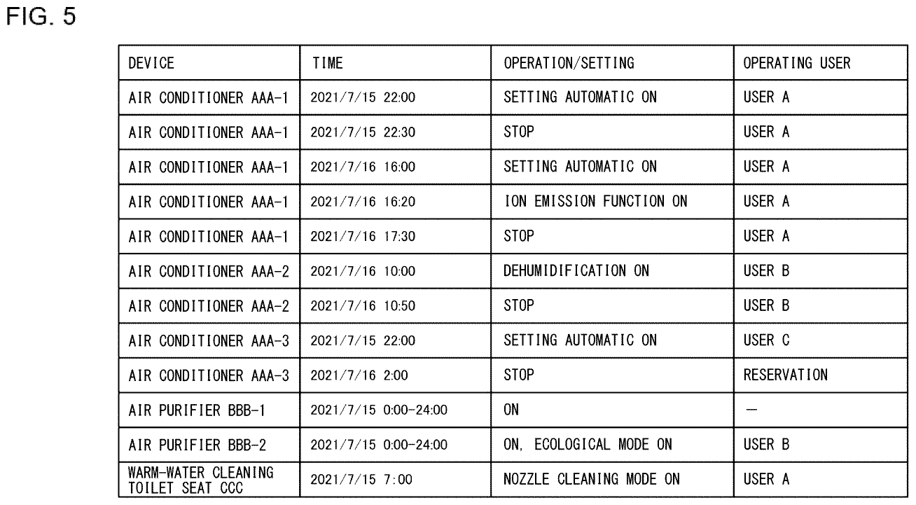

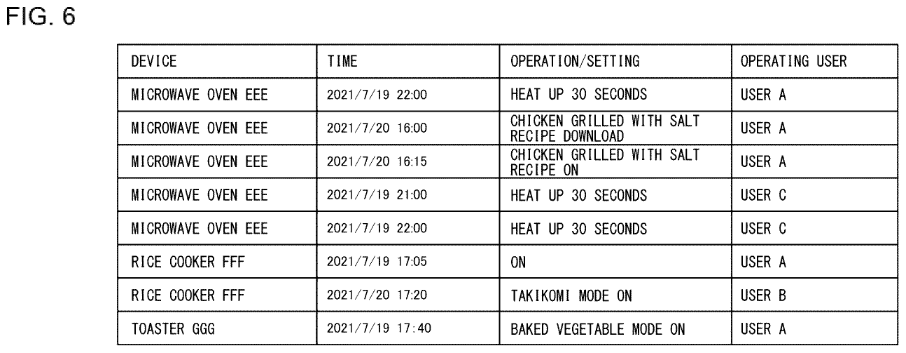

FIG. 5 illustrates an example of the operation information of the environment control devices and the seasonal devices. FIG. 6 illustrates an example of the operation information of the cooking devices. The operation information includes the identification information of the device 12 (“device” column), date and time when the device 12 is operated or time when the operation is input to the device 12 (“time” column), and information indicating the operation input to the device 12 or a state set in the device 12 (“operation/setting” column). The identification information of the device 12 may include a type of the device 12 (such as a washing machine) and a management number of the device 12. The operation input to the device 12 may include an operation of instruction of on or off of the operation. The information in the “operation/setting” column includes information indicating a function (for example, ion emission function or recipe download) operated in the device 12 and information indicating setting (for example, automatic setting) of the device 12.

The operation information further includes identification information of the user (operating user) who operates the device 12 (“operating user” column). For example, the device 12 may include an operation reception unit that is an interface for receiving the operation of the user of an instruction of the operation. The device 12 may set the operation/setting information and the information of the operating user input to the operation reception unit as the operation information. The device 12 may specify the user who inputs the operation to the device 12 using a detection result by the sensor 14. For example, the device 12 may specify the operating user by collating the information of the operating user detected by the sensor 14 with authentication information of the user stored in advance in the device itself, and set the information of the specified operating user in the operation information.

For example, in a case where the sensor 14 is a camera (image sensor), the sensor 14 may image the operating user. The device 12 may specify the operating user by collating a camera image obtained by imaging the operating user with an image of each user stored in advance in the device. As a variation, the sensor 14 may transmit the camera image obtained by imaging the operating user to the information processing apparatus 18. The operation information acquisition unit 54 of the information processing apparatus 18 may specify the operating user by collating the camera image with the image of each user stored in advance in the device itself, and add information of the specified user to the operation information transmitted from the device 12. A processor in the sensor 14 may execute processing of specifying the user, and the sensor 14 may transmit the information indicating the specified user to the device 12 or the information processing apparatus 18.

Returning to FIG. 4, the specifier 42 of the information processing apparatus 18 specifies the recommended function (also referred to as a recommended operation) of the device 12 with reference to the operation information of the device 12 acquired at S10 and the function correspondence rule stored in the function correspondence rule storage unit 36. The specifier 42 checks presence or absence of use for each attribute (also referred to as the function axis) included in the function correspondence rule, and in a case where there are a used device and unused device in a specific attribute, determines a function corresponding to the attribute in the unused device as the recommended function in the unused device.

In the embodiment, the specifier 42 specifies the attribute of the function operated in the first device 12 indicated by the operation information of the first device 12 acquired by the operation information acquisition unit 40 based on the function correspondence rule. For example, in a case where the operation information indicates that the ion emission function is operated in an air conditioner AAA, the specifier 42 specifies “air quality improvement”, “sterilization”, and “beauty” as the attributes of “ion emission function” operated in the air conditioner AAA as the first device 12.

The specifier 42 specifies the function (hereinafter, also referred to as “corresponding function”) of another device 12 associated with the attribute of the function operated in the first device 12 with reference to the function correspondence rule. With reference to the operation information, in a case where there is another device 12 in which the corresponding function is not operated, the specifier 42 specifies the other device 12 as the second device. The specifier 42 specifies the corresponding function of the second device as the recommended function for the user, and generates the recommended function information (S11).

For example, in a case of detecting that the “ion emission function” of the air conditioner AAA is used and that the “ion emission function” of a vacuum cleaner KKK having the same attribute “air quality improvement” as this function is unused based on the operation information, the specifier 42 specifies the “ion emission function” of the vacuum cleaner KKK as the recommended function. The specifier 42 generates display data of the content prompting use of the “ion emission function” of the vacuum cleaner KKK. The specifier 42 may generate the display data indicating the “ion emission function” of the vacuum cleaner KKK as the recommended function and indicating the “ion emission function” of the air conditioner AAA as the function already used by the user.

As described above, the “ion emission function” of the air conditioner AAA also has the attribute “beauty”. In a case of detecting that the “ion emission function” of the air conditioner AAA is used and that the “ion emission function” of a dryer LLL having the same attribute “beauty” as this function is unused based on the operation information, the specifier 42 specifies the “ion emission function” of the dryer LLL as the recommended function. The specifier 42 generates display data of the content prompting use of the “ion emission function” of the dryer LLL. The specifier 42 may generate the display data indicating the “ion emission function” of the dryer LLL as the recommended function and indicating the “ion emission function” of the air conditioner AAA as the function already used by the user. Furthermore, the “ion emission function” of the air conditioner AAA also has the attribute “sterilization”. In this case, similar to the above-described “beauty”, in a case of detecting the fact that the “ion emission function” of the air conditioner AAA is used and that the “ion emission function” of the device having the same attribute “sterilization” as this function, for example, a washing machine JJJ is unused, the “ion emission function” of the washing machine JJJ is specified as the recommended function.

The function information outputter 44 transmits the recommended function information generated by the specifier 42 to the information terminal 16 (S12). For example, the function information outputter 44 may transmit, to the information terminal 16, the display data of the content promoting use of the recommended function. The information terminal 16 causes the display unit to display the recommended function information transmitted from the information processing apparatus 18 upon reception of the recommended function information transmitted from the information processing apparatus 18 or upon the input of a predetermined operation (for example, an operation of an instruction of the display of the recommended function) from the user.

### Effects

According to the information processing apparatus 18 of the embodiment, by prompting the user to use the function of the second device 12 that conforms to the function operated in the first device 12, it is possible to promote recognition and use of the user of the function of the second device 12 that is not used by the user but easily conforms to intention and preference of the user. That is, according to the information processing apparatus 18, it is possible to support the user to be able to use the device 12 well. According to the information processing apparatus 18, it is possible to promote an operation according to the intention or preference of the user performed by the device 12.

In a case where the new device 12 is installed in the house, the user transmits identification information of the new device 12 from the information terminal 16 to the information processing apparatus 18. Alternatively, the new device 12 may autonomously transmit the identification information of the device itself to the information processing apparatus 18 upon connection to the LAN of the house. The rule update unit 46 of the information processing apparatus 18 transmits the identification information of the new device 12 to the device information server 20, and acquires the device information regarding the new device 12 from the device information server 20. As described above, the device information regarding the new device 12 includes the function correspondence rule regarding the new device 12. The rule update unit 46 stores the function correspondence rule regarding the new device 12 included in the device information acquired from the device information server 20 in the function correspondence rule storage unit 36.

For example, in a case where a facial treatment device MMM indicated in the function correspondence rule of FIG. 3 is newly installed in the house, the rule update unit 46 acquires device information including the function correspondence rule regarding the facial treatment device MMM from the device information server 20. The rule update unit 46 adds the function correspondence rule of the facial treatment device MMM (for example, lower two records indicated in the function correspondence rule of FIG. 3) acquired from the device information server 20 to the function correspondence rule stored in the function correspondence rule storage unit 36.

According to the information processing apparatus 18 of the embodiment, in a case where the new device 12 is installed in the environment of the user, the new device 12 can be automatically added to the device 12 to be analyzed by updating the function correspondence rule based on the information regarding the new device 12.

Given above is a description of the present disclosure based on the embodiment. The embodiment is intended to be illustrative only and it will be understood by those skilled in the art that various variations to combinations of constituting elements and processes of the embodiment are possible and that such variations are also within the scope of the present disclosure. Hereinafter, variations are described.

### First Variation

A first variation will be described. Even in a case where a function of a second device 12 corresponding to a function operated in a first device 12 is operated once or more, in a case where an operation frequency thereof is smaller than a predetermined threshold, a specifier 42 of an information processing apparatus 18 may regard that the corresponding function of the second device 12 is not operated, and specify the corresponding function of the second device 12 as a recommended function. The threshold of the operation frequency may be a ratio of the operation of the corresponding function of the second device 12 in the total number of times of the operation of the second device 12, and may be, for example, 10% or 20%.

A threshold of an operation frequency for a function that can be operated (set) in parallel with a main function of the second device 12 may be determined to be larger than a threshold of an operation frequency for a function that cannot be operated (set) in parallel with the main function of the second device 12. For example, an ecological mode of an air conditioner AAA can be set and operated in parallel with cooling and heating, which is the main function of the air conditioner AAA. Therefore, a threshold of the operation frequency for the ecological mode of the air conditioner AAA may be larger than a threshold of the operation frequency for another function (function that cannot be set and operated in parallel with cooling and heating) of the air conditioner AAA; for example, the former threshold may be 50% and the latter threshold may be 20%.

Note that, the threshold of the operation frequency for the function of the device 12 may be determined using a statistical value regarding a plurality of users or all users present in an environment (for example, in a house). Alternatively, the threshold of the operation frequency may be determined using a statistical value regarding a plurality of users having similar attributes, intentions, or preferences. For example, the specifier 42 of the information processing apparatus 18 (or a threshold setting unit not illustrated) may set the threshold of the operation frequency for an ion emission function of an air purifier BBB based on a ratio (statistical value) at which the user who uses the ion emission function of the air conditioner AAA uses the ion emission function of the air purifier BBB.

### Second Variation

A second variation will be described. A function information outputter 44 of an information processing apparatus 18 may transmit, to a second device 12, data (signal) indicating an instruction to operate a recommended function as information regarding a function (that is, the recommended function) of the second device 12 corresponding to a function operated in a first device 12. Accordingly, the operation of the recommended function in the second device 12 can be automatically started.

### Third Variation

A third variation will be described. As described in the embodiment, a plurality of devices 12 is classified into a plurality of categories. A specifier 42 of an information processing apparatus 18 may specify a function of a second device belonging to the same category as that of a first device as a recommended function in preference to the function of the second device belonging to a category different from that of the first device. On condition that no second device belonging to the same category as that of the first device is present in an environment, the specifier 42 may specify the function of the second device belonging to the category different from that of the first device as the recommended function.

For example, an air conditioner AAA and an air purifier BBB are classified into a category “environment control devices/seasonal devices”, and a vacuum cleaner KKK is classified into a category “living devices”. Herein, it is assumed that it is detected in operation information that an ion emission function is turned on in the air conditioner AAA. The specifier 42 specifies the ion emission function of the air purifier BBB and the ion emission function of the vacuum cleaner KKK as a corresponding function of the second device with an attribute “air quality improvement” as an axis. The specifier 42 of the present variation specifies the ion emission function of the air purifier BBB belonging to the same category as that of the air conditioner AAA as the recommended function in preference to the ion emission function of the vacuum cleaner KKK belonging to the category different from that of the air conditioner AAA. This is because it is considered that there is a higher possibility that a user wants to use the similar function in the device 12 of the same category.

Conversely, the specifier 42 may specify the function of the second device belonging to the category different from that of the first device as the recommended function in preference to the function of the second device belonging to the same category as that of the first device. On condition that no second device belonging to the category different from that of the first device is present in the environment, the specifier 42 may specify the function of the second device belonging to the same category as that of the first device as the recommended function. In the above-described example, the specifier 42 can specify the ion emission function of the vacuum cleaner KKK belonging to the category different from that of the air conditioner AAA as the recommended function in preference to the ion emission function of the air purifier BBB belonging to the same category as that of the air conditioner AAA. It is possible to cause the user to recognize that the function similar to the function of the first device 12 used by the user can also be used in the second device 12 belonging to the category different from that of the first device 12, and to promote use of the second device of the category different from that of the first device 12.

A priority level that defines whether to make the function of the second device 12 of the same category as that of the first device 12 the recommended function with priority or to make the function of the second device 12 of the category different from that of the first device 12 the recommended function with priority may be determined by the user. The specifier 42 may store the priority level transmitted from an information terminal 16 of a user or the priority level input to an input unit (a user interface and the like not illustrated) of the information processing apparatus 18, and make either the function of the second device 12 of the same category or the function of the second device 12 of the different category the recommended function with priority according to the priority level.

### Fourth Variation

A fourth variation related to the third variation will be described. A specifier 42 of an information processing apparatus 18 may determine whether to specify a function of a second device belonging to the same category as that of a first device with priority or specify the function of the second device belonging to a category different from that of the first device with priority according to a frequency or the number of times that the function of the second device 12 is used by a user.

Specifically, the information processing apparatus 18 may further include a recommended function storage unit and a statistical processing unit. The recommendation information storage unit may store information of a recommended function specified by the specifier 42, in other words, the recommended function of which a function information outputter 44 notifies the user. After notifying the user of the recommended function, the statistical processing unit may acquire statistical information regarding use of the recommended function. The statistical processing unit may derive a frequency or the number of times of use of the recommended function after notifying the user of the recommended function based on operation information. The specifier 42 may determine which of the function of the second device 12 of the same category and the function of the second device 12 of the different category is made the recommended function with priority or may switch a prioritized target according to the frequency or the number of times the recommended function is used derived by the statistical processing unit.

For example, in a situation in which the function of the second device 12 of the same category is made the recommended function with priority, in a case where the use frequency of the recommended function is smaller than a predetermined threshold, the specifier 42 may switch to make the function of the second device 12 of the different category the recommended function with priority. Note that, in a case where the recommended function information is provided to a specific target user, the statistical processing unit may acquire the statistical information (derive the frequency or the number of times) using the operation information in which an operating user is the target user described above out of the operation information acquired by the operation information acquisition unit 40. As another aspect, even in a case where the recommended function information is provided to the specific target user, the statistical processing unit may acquire the statistical information using both the operation information in which the operating user is the above-described target user and the operation information in which the operating user is a user other than the target user.

An index value (threshold) for the frequency or the number of times of use of the recommended function might depend on the use frequency and the like of the second device 12 that provides the recommended function. Therefore, the above-described index value (threshold) may be set for each category of the second device 12 that provides the recommended function.

A behavior of the user in an environment (for example, a usage aspect of the device 12) might change for each time period. Therefore, the statistical processing unit may derive a frequency or the number of times (hereinafter, the number of times is also referred to as “frequency”) for each time period that the recommended function is used for each time period indicated by the operation information. The specifier 42 may change a priority level that defines whether to make the function of the second device 12 of the same category as that of the first device 12 the recommended function with priority or to make the function of the second device 12 of the category different from that of the first device 12 the recommended function with priority according to the use frequency of the recommended function for each time period. In other words, the specifier 42 may switch between the function of the second device 12 of the same category and the function of the second device 12 of the different category to be made the recommended function with priority according to the usage frequency of the recommended function for each time period.

It is assumed that all users in a house use the device 12 of the house in nighttime hours on weekdays (for example, from 18:00 to 24:00), and that only a specific user (for example, the user A) uses the device 12 of the house in morning hours on holidays (for example, 6:00 to 12:00). In this case, the specifier 42 may change the priority level between the nighttime hours on weekdays and the morning hours on holidays.

### Fifth Variation

A fifth variation will be described. A specifier 42 of an information processing apparatus 18 may determine a major use time period of each of a plurality of devices 12 based on time (operation time or the like) indicated by a plurality of pieces of operation information of the plurality of devices 12. One of the use time period is, for example, nighttime hours on weekdays (for example, 18:00 to 24:00). In a case where a predetermined ratio (for example, 60%) or larger of one or more operations of a certain device 12 is performed in a specific time period, the specifier 42 may determine the specific time period as the major use time period of the device 12. The specifier 42 may determine a recommended function of the second device 12 using only the operation information indicating the operation in the major use time period. Conversely, the specifier 42 may determine the recommended function of the device 12 using only the operation information indicating the operation in a minor use time period (for example, daytime hours on weekdays (for example, 10:00 to 18:00)).

A function information outputter 44 of the information processing apparatus 18 may output, in the specific time period, information of the recommended function determined using only operation information in the specific time period. Alternatively, the function information outputter 44 may identify an operating user indicated by the operation information in the specific time period, and output the information of the recommended function determined using only the operation information in the specific time period to the information terminal 16 of the identified operating user.

### Sixth Variation

A sixth variation will be described. A storage unit 32 of an information processing apparatus 18 may store data of the upper limit number of outputs determined in advance for recommended function information to be output within a predetermined period. A function information outputter 44 of the information processing apparatus 18 may determine whether to output the information of the recommended function so that the number of times of outputting the recommended function information is within the upper limit number. In other words, in a case where the number of times of outputting the recommended function information within the predetermined period reaches the upper limit number, the function information outputter 44 may suppress output of new recommended function information in this period. The function information outputter 44 may use a priority level to determine whether to output the information of the recommended function.

The information processing apparatus 18 may further include a statistical processing unit (not illustrated). The statistical processing unit may derive the number of times of use of the function of the second device 12 indicated by the recommended function based on operation information acquired after the recommended function information is output. The statistical processing unit may derive a frequency of the use of the recommended function with respect to the number of times the recommended function information is output. The function information outputter 44 may increase the upper limit number of outputs of the recommended function information in a case where the number of times or frequency of use of the recommended function is a predetermined threshold (for example, 30%) or larger.

### Seventh Variation

A seventh variation will be described. A specifier 42 of an information processing apparatus 18 may specify a function of a second device installed in the vicinity of a first device 12 as a recommended function with priority further based on information indicating a position in which a plurality of devices 12 is installed. This is because it is considered that there is a high possibility that a user who uses the first device 12 wants to use a similar function as for the second device 12 present in the vicinity of the first device 12 or in the same space.

A function correspondence rule illustrated in FIG. 3 may include information indicating the installation position of each of the plurality of devices 12 in an environment (house or the like). The specifier 42 of the information processing apparatus 18 may extract the second device 12 installed in the same space (room and the like) as that of the first device 12 indicated by the operation information, and determine a recommended function out of functions of the extracted second device 12.

### Eighth Variation

An eighth variation will be described. A function information outputter 44 of an information processing apparatus 18 may transmit information regarding a recommended function to a second device 12 that provides the recommended function. The second device 12 may include a display unit such as a liquid crystal display and a display control unit that causes the display unit to display the recommended function information transmitted from the information processing apparatus 18. The second device 12 may detect that a user pays attention to the second device 12 (in other words, turning eyes to or focusing on the same) according to a detection result by a sensor 14 (for example, the sensor 14 provided in the device 12). The display control unit of the second device 12 may cause the display unit to display the recommended function information in a case where the device itself is the recommended target and this detects that the user pays attention to the device itself.

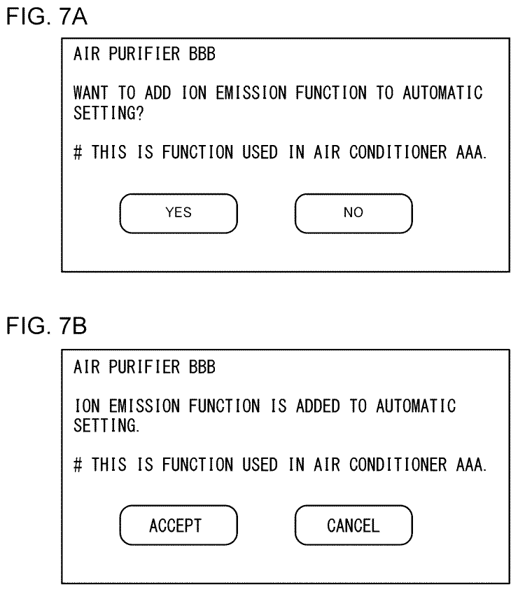

FIGS. 7A and 7B illustrate examples of the recommended function information displayed on the display unit of the second device 12 (herein, an air purifier BBB). FIG. 7A illustrates an example of a case where the recommended function information provided from the information processing apparatus 18 indicates that an ion emission function of the air purifier BBB is the recommended function.

FIG. 7B illustrates an example of a case where the recommended function information provided from the information processing apparatus 18 indicates that the ion emission function of the air purifier BBB is the recommended function, and a case where the information processing apparatus 18 automatically turns on the ion emission function of the air purifier BBB. The recommended function information illustrated in FIGS. 7A and 7B includes information regarding the first device 12 (air conditioner AAA) in addition to the information regarding the ion emission function of the air purifier BBB.

### Ninth Variation

A ninth variation will be described. A function correspondence rule may include information regarding a function of a third device 12 that is not installed in an environment in which a plurality of devices 12 is installed. In place of or in addition to this, the function correspondence rule may include information regarding a function not introduced into the device 12 already installed in the environment. The function not introduced into the device 12 may be a function implemented in a computer program that can be downloaded from an external device via a communication network 22 and installed in the device 12, in other words, may be a function that can be added afterwards to the installed device 12.

A specifier 42 may specify the function of the third device 12 or the function not introduced into a second device 12 corresponding to a function operated in a first device with reference to the function correspondence rule. In this case, a function information outputter 44 may provide a user with information regarding introduction of the third device 12 or information regarding purchase of the function not introduced into the second device 12, and may transmit the information to an information terminal 16 of the user.

The information regarding the introduction of the third device may be information for supporting/promoting the purchase of the third device 12, and may include detailed information, price information, a discount coupon and the like of the third device 12. The information regarding the purchase of the function not introduced into the device 12 may be information for supporting/promoting the purchase of the function not introduced, and may include detailed information, price information, a discount coupon and the like of the function not introduced. The information regarding the introduction of the third device 12 or the information regarding the purchase of the function not introduced into the second device 12 may be periodically provided from a device information server 20 to the information processing apparatus 18 and stored in a storage unit 32 of the information processing apparatus 18. Alternatively, the information processing apparatus 18 may further include a device information acquisition unit that dynamically acquires, from the device information server 20, the information regarding the third device 12 or the function not introduced in a case where the specifier 42 specifies the function of the third device 12 or the function not introduced into the second device 12.

In a case of receiving information indicating that a device life of a certain device 12 in the environment will expire soon or that the device 12 fails, the specifier 42 may specify the third device 12 related to the certain device 12 described above that is not present in the environment, and the function information outputter 44 may provide information of the third device 12 to the user. The third device 12 may be the device 12 of the same category as that of the certain device 12 described above or may be the device 12 having a function corresponding to the function of the certain device 12 described above.

### Tenth Variation

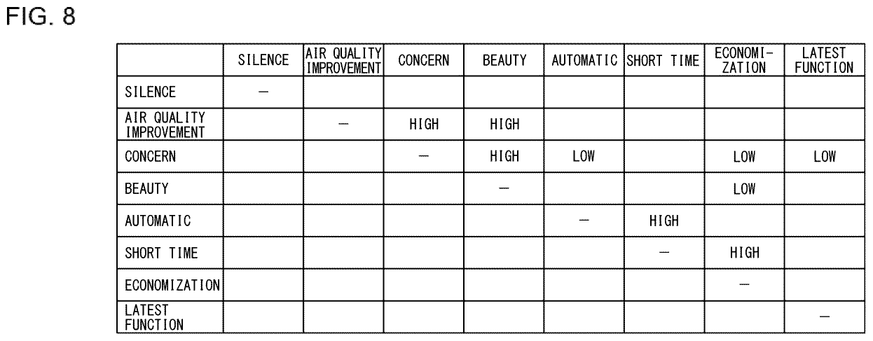

A tenth variation will be described. A function correspondence rule may include information (hereinafter, also referred to as “function attribute-related information”) indicating a degree of relation between attributes of functions. FIG. 8 illustrates an example of the function attribute-related information. The drawing illustrates the degree of relation of a plurality of attributes arranged horizontally with respect to each of a plurality of attributes arranged vertically. “High” indicates a high degree of relation, “low” indicates a low degree of relation, and no value (blank) indicates a medium degree of relation.

Herein, the priority order of recommended functions is determined based on a use frequency. In a case where the attribute of the function of the lowest use frequency is “concern”, a specifier 42 of an information processing apparatus 18 specifies the function belonging to the attribute “concern” as the recommended function with the highest priority order. Thereafter, the specifier 42 specifies a function belonging to an attribute “beauty” having a high degree of relation with the attribute “concern” as the recommended function with the next highest priority order according to the function attribute-related information in FIG. 8. In contrast, the specifier 42 lowers the priority order as the specified recommended function as for the function belonging to an attribute “automatic”, “economization”, or “latest function” of which degree of relation with the attribute “concern” is low.

### Effects

According to this variation, in a case where the recommended function information is output a plurality of times, it is easy to output a plurality of pieces of recommended function information having a high degree of relation (in other words, compatible) based on the degree of relation (in other words, compatibility) between the attributes of the functions. This makes it easy to provide a plurality of pieces of recommended function information useful for the user.

In the exemplary embodiment or the variations above, the plurality of functional blocks provided in the information processing apparatus 18 may be implemented by being distributed across a plurality of apparatuses. The process similar to that of the information processing apparatus 18 of the exemplary embodiment may be implemented by causing these plurality of apparatuses to transmit and receive data to and from each other and coordinating them as a system.

Any combination of the exemplary embodiment and the variation described above will also be useful as the embodiment of the present disclosure. New embodiments created by the combination provide the advantages of exemplary embodiments and the variation combined. It will also be understood by those skilled in the art that the functions that the constituting elements recited in claims should achieve are implemented either alone or in combination by the constituting elements shown in the exemplary embodiment and the variations.

### Additional Note

The description of the embodiment and the variation described above discloses the following technologies.

### Technology 1

An information outputting method, including:
acquiring operation information of a plurality of devices;
specifying a function of a second device that is not operated in a case where the function of the second device corresponding to a function operated in a first device is not operated based on the operation information and function information in which common functions are associated with each other out of functions of each of the plurality of devices in advance; and
outputting information regarding the specified function of the second device.

According to this information outputting method, in an environment in which the plurality of devices is installed, it is possible to support the operation of the second device to conform to the operation of the first device.

### Technology 2

The information outputting method according to technology 1, in which
the function information is information in which the functions of the plurality of devices having a common attribute are associated with each another.

According to this information outputting method, it is easy to appropriately set a correspondence relationship of the functions between the devices.

### Technology 3

The information outputting method according to technology 1 or 2, in which
in the specifying, even when the function of the second device corresponding to the function operated in the first device is operated, in a case where a frequency is smaller than a predetermined threshold, the function of the second device is regarded to be not operated.

According to this information outputting method, in a case where an operation frequency of the function of the second device corresponding to the function operated in the first device is low, information regarding the function of the second device can be output, and it is possible to support the operation of the second device to conform to the operation of the first device.

### Technology 4

The information outputting method according to any one of technologies 1 to 3, in which
in the outputting, an instruction to operate the function of the second device corresponding to the function operated in the first device is transmitted to the second device.

According to this information outputting method, the operation of the function of the second device corresponding to the function operated in the first device can be automatically started.

### Technology 5

The information outputting method according to any one of technologies 1 to 4, in which
in a case where a new device is installed in an environment in which the plurality of devices is installed, the function information is updated based on information regarding the new device.

According to this information outputting method, the new device installed in the environment can be automatically added to the device to be analyzed.

### Technology 6

The information outputting method according to any one of technologies 1 to 5, in which
the plurality of devices is divided into a plurality of categories, and
in the specifying, the function of the second device belonging to the same category as the category of the first device is specified with priority.

According to this information outputting method, the function of the second device to be output can be more appropriately specified in consideration of the category of the device.

### Technology 7

The information outputting method according to any one of technologies 1 to 5, in which
the plurality of devices is divided into a plurality of categories,
in the outputting, the information regarding the specified function of the second device is provided to a user, and
it is determined whether to specify the function of the second device belonging to the same category as the category of the first device with priority or specify the function of the second device belonging to a category different from the category of the first device with priority according to a frequency at which the function of the second device is used by the user.

According to this information outputting method, it is easy to appropriately determine whether to specify the function of the second device belonging to the same category as that of the first device with priority or to specify the function of the second device belonging to the category different from that of the first device with priority.

### Technology 8

The information outputting method according to any one of technologies 1 to 7, in which
in the specifying, the function of the second device installed in the vicinity of the first device is specified with priority further based on information indicating a position in which the plurality of devices is installed.

According to this information outputting method, it is easy to specify an appropriate device as the second device.

### Technology 9

The information outputting method according to any one of technologies 1 to 8, in which
the function information includes information regarding a function of a third device that is not installed in the environment in which the plurality of devices is installed or information regarding a function not installed in the second device, and
in the specifying, in a case where the function of the third device or the function not introduced into the second device corresponding to the function operated in the first device is specified, in the outputting, information regarding introduction of the third device or information regarding introduction of the function not introduced into the second device is provided to a user.

According to this information outputting method, appropriate information can be easily provided to the user, and introduction (for example, purchase and the like) of a new device or a new function by the user can be promoted.

### Technology 10

An information processing apparatus, including:
an acquisition unit structured to acquire operation information of a plurality of devices;
a specifier structured to specify a function of a second device that is not operated in a case where the function of the second device corresponding to a function operated in a first device is not operated based on the operation information and function information in which common functions are associated with each other out of functions of each of the plurality of devices in advance; and
an outputter structured to output information regarding the specified function of the second device.

According to this information processing apparatus, in an environment in which the plurality of devices is installed, it is possible to support the operation of the second device to conform to the operation of the first device.

### Technology 11

A computer program structured to cause a computer to execute
acquiring operation information of a plurality of devices;
specifying a function of a second device that is not operated in a case where the function of the second device corresponding to a function operated in a first device is not operated based on the operation information and function information in which common functions are associated with each other out of functions of each of the plurality of devices in advance; and
outputting information regarding the specified function of the second device.

According to this computer program, in an environment in which the plurality of devices is installed, it is possible to cause the computer to execute processing of supporting the operation of the second device to conform to the operation of the first device.

While various embodiments have been described herein above, it is to be appreciated that various changes in form and detail may be made without departing from the spirit and scope of the invention(s) presently or hereafter claimed.

### CROSS-REFERENCE TO RELATED APPLICATION

This application is based upon and claims the benefit of priority from the prior Japanese Patent Application No. 2022-124152, filed on Aug. 3, 2022, the entire contents of which are incorporated herein by reference.

What is claimed is:

1. An information outputting method, wherein
a computer executes
acquiring operation information of a plurality of devices;
specifying a function of a second device that is not operated in a case where the function of the second device corresponding to a function operated in a first device is not operated based on the operation information and function information in which common functions are associated with each other out of functions of each of the plurality of devices in advance; and
outputting information regarding the specified function of the second device,
the plurality of devices is divided into a plurality of categories, and
in the specifying, the function of the second device belonging to the same category as the category of the first device is specified with priority.

2. The information outputting method according to claim 1, wherein
the function information is information in which the functions of the plurality of devices having a common attribute are associated with each another.

3. The information outputting method according to claim 1, wherein
in the specifying, even when the function of the second device corresponding to the function operated in the first device is operated, in a case where a frequency is smaller than a predetermined threshold, the function of the second device is regarded to be not operated.

4. The information outputting method according to claim 1, wherein
in the outputting, an instruction to operate the function of the second device corresponding to the function operated in the first device is transmitted to the second device.

5. The information outputting method according to claim 1, wherein
in a case where a new device is installed in an environment in which the plurality of devices is installed, the function information is updated based on information regarding the new device.

6. The information outputting method according to claim 1, wherein
in the outputting, the information regarding the specified function of the second device is provided to a user, and
it is determined whether to specify the function of the second device belonging to the same category as the category of the first device with priority or specify the function of the second device belonging to a category different from the category of the first device with priority according to a frequency at which the function of the second device is used by the user.

7. The information outputting method according to claim 1, wherein
in the specifying, the function of the second device installed in the vicinity of the first device is specified with priority further based on information indicating a position in which the plurality of devices is installed.

8. The information outputting method according to claim 1, wherein
the function information includes information regarding a function of a third device that is not installed in the environment in which the plurality of devices is installed or information regarding a function not installed in the second device, and
in the specifying, in a case where the function of the third device or the function not introduced into the second device corresponding to the function operated in the first device is specified, in the outputting, information regarding introduction of the third device or information regarding introduction of the function not introduced into the second device is provided to a user.

9. An information processing apparatus, comprising:
an acquisition unit structured to acquire operation information of a plurality of devices;
a specifier structured to specify a function of a second device that is not operated in a case where the function of the second device corresponding to a function operated in a first device is not operated based on the operation information and function information in which common functions are associated with each other out of functions of each of the plurality of devices in advance; and
an outputter structured to output information regarding the specified function of the second device, wherein
the plurality of devices is divided into a plurality of categories, and
the specifier specifies the function of the second device belonging to the same category as the category of the first device with priority.

10. A non-transitory computer-readable storage medium storing a computer program structured to cause a computer to execute
acquiring operation information of a plurality of devices;
specifying a function of a second device that is not operated in a case where the function of the second device corresponding to a function operated in a first device is not operated based on the operation information and function information in which common functions are associated with each other out of functions of each of the plurality of devices in advance; and
outputting information regarding the specified function of the second device, wherein
the plurality of devices is divided into a plurality of categories, and
in the specifying, the function of the second device belonging to the same category as the category of the first device is specified with priority.
